(19) United States
(12) Patent Application Publication
(10) Pub. No.: US 2017/0294033 A1
(43) Pub. Date: Oct. 12, 2017

(54) DOSE EFFICIENT X-RAY DETECTOR AND METHOD

(71) Applicant: VAREX IMAGING CORPORATION, Salt Lake City, UT (US)

(72) Inventors: Arundhuti GANGULY, San Jose, CA (US); Ivan P. MOLLOV, Mountain View, CA (US); Richard E. COLBETH, Los Altos, CA (US)

(73) Assignee: VAREX IMAGING CORPORATION, Salt Lake City, UT (US)

(21) Appl. No.: 15/092,578

(22) Filed: Apr. 6, 2016

(51) Int. Cl. G06T 11/00; G06T 7/00

(52) U.S. Cl. CPC G06T 11/005; G06T 7/0012; G06T 7/0024; G06T 2207/10116; G06T 2207/10144

(57) ABSTRACT

An apparatus for use in medical imaging, includes: an imager configured to receive radiation, and to generate electrical signals in response to the received radiation, wherein the imager comprises imaging elements; and a processing unit configured to generate a video, wherein the video comprises a first image having a first image resolution and a second image having a second image resolution that is different from the first image, the first image and the second image generated using the imager.

### FIELD

The field of the application relates to medical imaging, and more particularly, to system and method for obtaining images using radiation.

### BACKGROUND

X-ray imaging has been used to obtain images of internal regions of patients. X-ray imaging may be performed as a static image for allowing a physician to view an internal region of a patient at a certain point in time. X-ray imaging may also be performed in real time to obtain a sequence of images forming a video during a medical procedure for allowing a physician to view an internal region of a patient while a medical procedure is being performed.

In the case of the static image, the dose associated with the x-ray image applied to the patient is relatively small. However, in the case of real time imaging, the dose applied to the patient can be significant because multiple x-ray images are generated to form the video for the medical procedure.

Apparatus and method for lowering dose to patient during x-ray imaging are described herein.

### SUMMARY

An apparatus for use in medical imaging, includes: an imager configured to receive radiation, and to generate electrical signals in response to the received radiation, wherein the imager comprises imaging elements; and a processing unit configured to generate a video, wherein the video comprises a first image having a first image resolution and a second image having a second image resolution that is different from the first image, the first image and the second image generated using the imager.

Optionally, the first image comprises un-binned image signals.

Optionally, the second image comprises binned image signals.

Optionally, the first image has a first effective pixel size, and the second image has a second effective pixel size that is different from the first effective pixel size.

Optionally, the first image is associated with a first dose, and the second image is associated with a second dose that is different from the first dose.

Optionally, the apparatus further includes a collimator configured to operate with the imager.

Optionally, the collimator is configured to provide a first imaging window for allowing the imager to generate the first image with a first size.

Optionally, the collimator is also configured to provide a second imaging window that is different from the first imaging window for allowing the imager to generate the second image with a second size different from the first size.

Optionally, the collimator comprises a static collimator or a dynamic collimator.

Optionally, the processing unit is configured to output the first image and the second image together as respective parts of an image frame.

Optionally, the processing unit is configured to output the first image and the second image sufficiently close in time so that they have an appearance of a single image frame.

Optionally, the processing unit is configured to create the second image.

Optionally, the processing unit comprises circuitry for creating the second image by binning two or more image signals from the imager to form a pixel signal.

Optionally, the processing unit is configured to receive the second image from circuitry.

Optionally, the circuitry is configured to create the second image by binning two or more image signals from the imager to form a pixel signal.

Optionally, the second image is based at least in part on previously generated images.

Optionally, at least one of the previously generated images is generated using a different dose compared to the first image.

Optionally, the processing unit is configured to recursively process the previously generated images to obtain the second image.

Optionally, the apparatus further includes a signal gain changer to provide a gain change for the second image.

Optionally, the processing unit is configured to generate a first plurality of images and a second plurality of images in an interleaving manner so that they collectively form the video; and wherein one of the first plurality of images comprises the first image, and one of the second plurality of images comprises the second image.

Optionally, the processing unit is configured to provide one of the first plurality of images after N number of images from the second plurality of images in the video.

Optionally, the processing unit is configured to provide one of the second plurality of images after N number of images from the first plurality of images in the video.

Optionally, one of the second plurality of images is generated using a different dose compared to one of the first plurality of images.

Optionally, the processing unit is configured to generate a first plurality of images, wherein one of the first plurality of images comprises the first image.

Optionally, the processing unit is also configured to provide a second plurality of images; wherein one of the second plurality of images comprises the second image.

Optionally, the first plurality of images and the second plurality of images together form the video.

Optionally, the first plurality of images has a first frame rate, and the second plurality of images has a second frame rate that is different from the first frame rate.

Optionally, the first plurality of images has a first frame rate, and the second plurality of images has a second frame rate that is the same as the first frame rate.

Optionally, the first plurality of images and the second plurality of images are interleaved in the video.

Optionally, the processing unit is configured to provide the first plurality of images in a first frame region of the video, and the second plurality of images in a second frame region of the video, the first frame region being inside the second frame region.

Optionally, the first image resolution is higher than the second image resolution.

Optionally, the first image resolution is for a region of interest (ROI).

An apparatus for use in medical imaging, includes: an imager configured to receive radiation, and to generate electrical signals in response to the received radiation, wherein the imager comprises imaging elements; and a processing unit configured to provide a first plurality of images and a second plurality of images in an interleaving manner so that they collectively form a video, wherein the first plurality of images and the second plurality of images are generated using the imager; wherein one of the first plurality of images has a first image resolution, and one of the second plurality of images has a second image resolution that is different from the first image resolution.

Optionally, the processing unit is configured to provide one of the first plurality of images after N number of images from the second plurality of images in the video.

Optionally, the processing unit is configured to provide one of the second plurality of images after N number of images from the first plurality of images in the video.

Optionally, one of the second plurality of images is generated using a different dose compared to one of the first plurality of images.

Optionally, the processing unit is configured to output the one of the first plurality of images and the one of the second plurality of images together as respective parts of an image frame.

Optionally, the processing unit is configured to output the one of the first plurality of images and the one of the second plurality of images sufficiently close in time so that they have an appearance of a single image frame.

Optionally, the processing unit comprises circuitry for creating the one of the second plurality of images by binning two or more image signals from the imager to form a pixel signal.

Optionally, the one of the second plurality of images is based at least in part on previously generated images.

Optionally, at least one of the previously generated images is generated using a different dose compared to the one of the first plurality of images.

Optionally, the processing unit is configured to recursively process the previously generated images to obtain the one of the second plurality of images.

An apparatus for use in medical imaging includes: an imager configured to receive radiation, and to generate electrical signals in response to the received radiation, wherein the imager comprises imaging elements; and a processing unit configured to provide a first plurality of images and a second plurality of images, the first plurality of images and the second plurality of images together forming a video; wherein the first plurality of images and the second plurality of images are generated using the imager, and wherein one of the first plurality of images has a first image resolution, and one of the second plurality of images has a second image resolution that is different from the first image resolution; and wherein one of the first plurality of images and one of the second plurality of images form an image frame in the video.

Optionally, the first plurality of images has a first frame rate, and the second plurality of images has a second frame rate that is different from the first frame rate.

Optionally, the first plurality of images has a first frame rate, and the second plurality of images has a second frame rate that is the same as the first frame rate.

Optionally, the processing unit is configured to provide the first plurality of images in a first frame region of the video, and the second plurality of images in a second frame region of the video, the first frame region being inside the second frame region.

An apparatus for use in medical imaging, includes: an imager configured to receive radiation, and to generate electrical signals in response to the received radiation, wherein the imager comprises imaging elements; and a processing unit configured to provide a first plurality of images and a second plurality of images, the first plurality of images and the second plurality of images together forming a video; wherein the first plurality of images and the second plurality of images are generated using the imager; and wherein the first plurality of images has a first frame rate, the second plurality of images has a second frame rate that is different from the first frame rate.

Optionally, the second frame rate is lower than the first frame rate.

Optionally, the first plurality of images and the second plurality of images are interleaved in the video.

Optionally, the processing unit is configured to provide the first plurality of images in a first frame region of the video, and the second plurality of images in a second frame region of the video, the first frame region being inside the second frame region.

Optionally, one of the first plurality of images has a first image resolution, and one of the second plurality of images has a second image resolution that is lower than the first image resolution.

An apparatus for use in medical imaging, includes: an imager configured to receive radiation, and to generate electrical signals in response to the received radiation, wherein the imager comprises imaging elements; and a processing unit configured to generate a video, wherein the video comprises a first image having a first matrix size and a second image having a second matrix size that is different from the first matrix size, the first image and the second image generated using the imager; wherein the first image corresponds with a first imaging dose, and the second image corresponds with a second imaging dose that is different from the first imaging dose.

An apparatus for use in medical imaging, includes: an imager configured to receive radiation, and to generate electrical signals in response to the received radiation, wherein the imager comprises imaging elements; and a processing unit configured to provide a first plurality of images and a second plurality of images in an interleaving manner so that they collectively form a video, wherein the first plurality of images and the second plurality of images are generated using the imager; wherein one of the first plurality of images has a first matrix size, and one of the second plurality of images has a second matrix size that is different from the first matrix size; and wherein the one of the first plurality of images corresponds with a first imaging dose, and the one of the second plurality of images corresponds with a second imaging dose that is different from the first imaging dose.

A method of medical imaging includes: generating a first image and a second image using signals from an imager, the imager configured to receive radiation, and to generate electrical signals in response to the received radiation, wherein the imager comprises imaging elements; and operating a display for displaying a video, wherein the video comprises the first image having a first image resolution and the second image having a second image resolution that is lower than the first image.

Optionally, the first image comprises un-binned image signals.

Optionally, the second image comprises binned image signals.

Optionally, the first image has a first effective pixel size, and the second image has a second effective pixel size that is larger than the first effective pixel size.

Optionally, the first image is associated with a first dose, and the second image is associated with a second dose that is lower than the first dose.

Optionally, the method further includes using a collimator to perform radiation beam collimation.

Optionally, the method further includes using a collimator to provide a first imaging window for allowing the imager to generate the first image with a first size.

Optionally, the method further includes using the collimator to provide a second imaging window that is larger than the first imaging window for allowing the imager to generate the second image with a second size larger than the first size.

Optionally, the collimator comprises a static collimator or a dynamic collimator.

Optionally, the first image and the second image are displayed together as respective parts of an image frame.

Optionally, the first image and the second image are displayed sufficiently close in time so that they have an appearance of a single image frame.

Optionally, the second image is generated by a processing unit.

Optionally, the processing unit comprises circuitry, and the second image is created by the circuitry by binning two or more image signals from the imager to form a pixel signal.

Optionally, the method further includes receiving, by a processing unit, the second image from circuitry.

Optionally, the second image is created by the circuitry by binning two or more image signals from the imager to form a pixel signal.

Optionally, the second image is based at least in part on previously generated images.

Optionally, at least one of the previously generated images is generated using a lower dose compared to the first image.

Optionally, the second image is generated by a processing unit by recursively processing previously generated images.

Optionally, the second image is generated by using charge storage capacitors for providing a gain increase.

Optionally, the method further includes displaying a first plurality of images and a second plurality of images in an interleaving manner so that they collectively form the video; wherein one of the first plurality of images comprises the first image, and one of the second plurality of images comprises the second image.

Optionally, one of the first plurality of images is displayed after N number of images from the second plurality of images are displayed.

Optionally, one of the second plurality of images is displayed after N number of images from the first plurality of images are displayed.

Optionally, one of the second plurality of images is generated using a lower dose compared to one of the first plurality of images.

Optionally, the method further includes operating the display to display a first plurality of images, wherein one of the first plurality of images comprises the first image.

Optionally, the method further includes operating the display to display a second plurality of images; wherein one of the second plurality of images comprises the second image.

Optionally, the first plurality of images and the second plurality of images together form the video.

Optionally, the first plurality of images has a first frame rate, and the second plurality of images has a second frame rate that is lower than the first frame rate.

Optionally, the first plurality of images has a first frame rate, and the second plurality of images has a second frame rate that is the same as the first frame rate.

Optionally, the first plurality of images and the second plurality of images are interleaved in the video.

Optionally, the first plurality of images is displayed in a first frame region of the video, and the second plurality of images is displayed in a second frame region of the video, the first frame region being inside the second frame region.

A method of medical imaging includes: generating a first plurality of images and a second plurality of images using signals from an imager, the imager configured to receive radiation, and to generate electrical signals in response to the received radiation, wherein the imager comprises imaging elements; and operating a display to display the first plurality of images and the second plurality of images in an interleaving manner so that they collectively form a video, wherein one of the first plurality of images has a first image resolution, and one of the second plurality of images has a second image resolution that is lower than the first image resolution.

Optionally, one of the first plurality of images is displayed after N number of images from the second plurality of images are displayed.

Optionally, one of the second plurality of images is displayed after N number of images from the first plurality of images are displayed.

Optionally, one of the second plurality of images is generated using a lower dose compared to one of the first plurality of images.

A method of medical imaging includes: generating a first plurality of images and a second plurality of images using signals from an imager, the imager configured to receive radiation, and to generate electrical signals in response to the received radiation, wherein the imager comprises imaging elements; and operating a display to display the first plurality of images and the second plurality of images, the first plurality of images and the second plurality of images together forming a video; wherein one of the first plurality of images has a first image resolution, and one of the second plurality of images has a second image resolution that is lower than the first image resolution; and wherein one of the first plurality of images and one of the second plurality of images form an image frame in the video.

Optionally, the first plurality of images has a first frame rate, and the second plurality of images has a second frame rate that is lower than the first frame rate.

Optionally, the first plurality of images has a first frame rate, and the second plurality of images has a second frame rate that is the same as the first frame rate.

Optionally, the first plurality of images is displayed in a first frame region of the video, and the second plurality of images is displayed in a second frame region of the video, the first frame region being inside the second frame region.

A method of medical imaging includes: generating a first plurality of images and a second plurality of images using signals from an imager, the imager configured to receive radiation, and to generate electrical signals in response to the received radiation, wherein the imager comprises imaging elements; and operating a display to display the first plurality of images and the second plurality of images, the first plurality of images and the second plurality of images together forming a video; wherein the first plurality of images has a first frame rate, the second plurality of images has a second frame rate that is different from the first frame rate.

Optionally, the second frame rate is lower than the first frame rate.

Optionally, the first plurality of images and the second plurality of images are interleaved in the video.

Optionally, the first plurality of images is displayed in a first frame region of the video, and the second plurality of images is displayed in a second frame region of the video, the first frame region being inside the second frame region.

Optionally, one of the first plurality of images has a first image resolution, and one of the second plurality of images has a second image resolution that is lower than the first image resolution.

Other and further aspects and features will be evident from reading the following detailed description.

### DESCRIPTION OF THE DRAWINGS

The drawings illustrate the design and utility of embodiments, in which similar elements are referred to by common reference numerals. These drawings are not necessarily drawn to scale. In order to better appreciate how the above-recited and other advantages and objects are obtained, a more particular description of the embodiments will be rendered, which are illustrated in the accompanying drawings. These drawings depict only exemplary embodiments and are not therefore to be considered limiting in the scope of the claims.

FIG. 1 illustrates an imaging system.

FIG. 2 illustrates an image with a binned region and an un-binned region.

FIG. 3 illustrates an example of an image with different resolutions.

FIGS. 4A and 4B illustrate examples of images having different resolutions in each image.

FIG. 5 illustrates a sequence of images that involve binned images and un-binned images.

FIG. 6 illustrates a sequence of images with regions-of-interest and overview images.

FIGS. 7A-7D illustrates different imaging methods in accordance with different embodiments.

FIG. 8 illustrates a specialized processing system with which embodiments described herein may be implemented.

### DETAILED DESCRIPTION

Various embodiments are described hereinafter with reference to the figures. It should be noted that the figures are not drawn to scale and that elements of similar structures or functions are represented by like reference numerals throughout the figures. It should also be noted that the figures are only intended to facilitate the description of the embodiments. They are not intended as an exhaustive description of the invention or as a limitation on the scope of the invention. In addition, an illustrated embodiment needs not have all the aspects or advantages shown. An aspect or an advantage described in conjunction with a particular embodiment is not necessarily limited to that embodiment and can be practiced in any other embodiments even if not so illustrated, or if not so explicitly described.

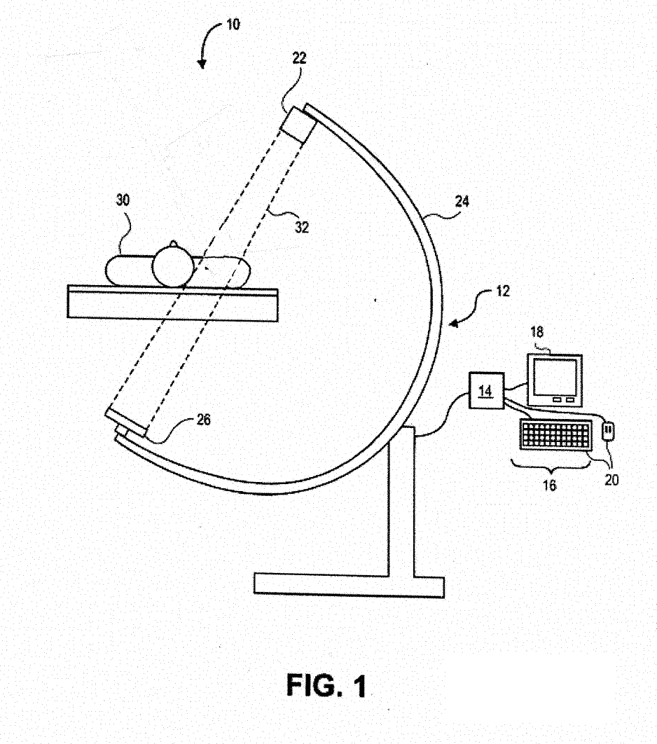

FIG. 1 illustrates an imaging system 10. The imaging system 10 includes a fluoroscope 12, a processing unit 14, and a work station 16 having a display 18 and a user interface 20, such as a keyboard, a mouse, a touch pad, etc. The fluoroscope 12 is illustrated as a C-arm fluoroscope in which an x-ray source 22 is mounted on a structural member or C-arm 24 opposite to an imager 26, which is configured to receive and detect x-ray emitting from the x-ray source 22. The C-arm 24 is capable of moving about a patient for producing two dimensional projection images of the patient from different angles. In other embodiments, the imaging system 10 may not include a C-arm, and may have other forms. Also, in other embodiments, the imaging system 10 may have other types of imaging device instead of the fluoroscope 12. For example, in other embodiments, the imaging system 10 may have a computed tomography (CT) device for generating projection images using the source 22 and imager 26, a tomosynthesis imaging device for generating tomosynthesis images, or other types of imaging device that provides radiation for imaging. In addition, the imaging system 10 is not limited to being a stand-alone device like that shown in the figure. In other embodiments, the imaging system 10 may be integrated with a treatment device.

The processing unit 14 may be a component of the work station 16, or alternative, a separate component that is communicatively connected (e.g., by wire or wirelessly) to the work station 16. The processing unit may alternatively be a component of the imager 26, or a component of a control system that operates the x-ray source 22 and/or the imager 26.

During use of the imaging system 10, a patient 30 is positioned between the x-ray source 22 and the imager 26. A x-ray beam 32 is then directed towards a target region 34 within the patient 30, and is attenuated as it passes through the patient 30. The imager 26 receives the attenuated x-ray beam 32, and generates electrical signals in response thereto. The electrical signals are transmitted to the processing unit 14, which is configured to generate images in the display 18 based on the electrical signals.

In some embodiments, the processing unit 14 is configured to operate the display 18 for displaying a video, wherein the video comprises a first image having a first image resolution and a second image having a second image resolution that is lower than the first image. The first image and the second image may be generated using the same imager 26.

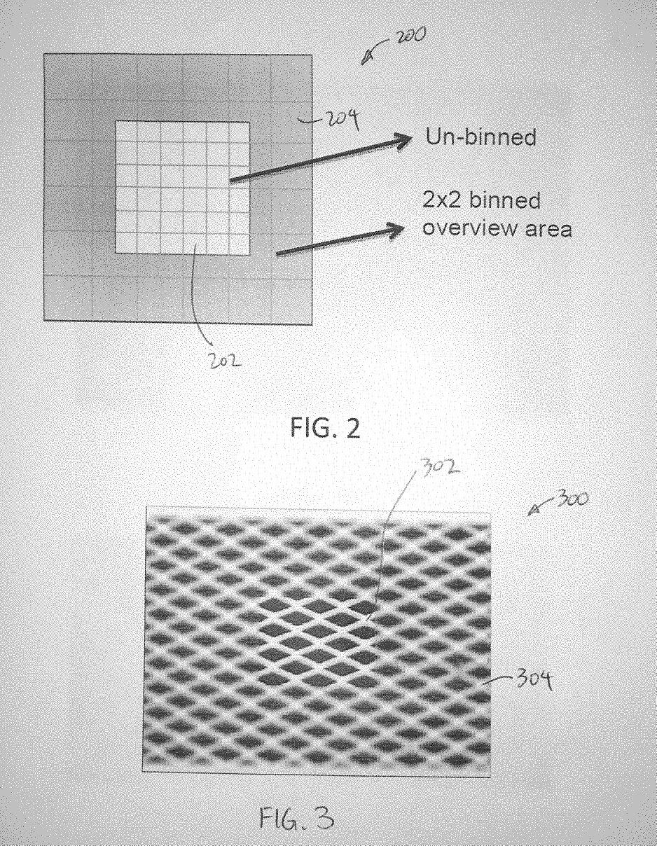

In some cases, the first image and the second image may form respective parts of an image frame in the video. FIG. 2 illustrates an example of an image frame 200 having a first image 202 and a second image 204. The first image 202 comprises un-binned image signals, and the second image 204 comprises binned image signals. In particular, each pixel in the first image 202 is associated with a corresponding one of the image elements in the imager 26. Thus, the first image 202 is considered as having “un-binned” image signals. On the other hand, each pixels in the second image 204 is obtained by combining multiple image signals from the respective image elements of the imager 26. For example, if 2 rows and 2 column of image signals are binned (combined), then the resulting pixel is considered to be 2×2 binned. If 2 rows and 1 column of image signals are binned, then the resulting pixel is considered to be 2×1 binned. Binning image signals increases imaging speed and performance of image sensors. However, because the effective pixel size (i.e., area in the image per pixel) is increased due to binning, the resulting image has sparser pixels and lower image resolution. In the illustrated example, the effective pixel size of the second image 204 is larger than the effective pixel size of the first image 202.

Also, in the illustrated example, the second image 204 may be obtained using lower x-ray dose per image area compared to the first image 202. For example, a 2×2 binned pixel may use 4 times lower x-ray dose to obtain compared to an un-binned pixel. As another example, a 3×3 binned pixel may use 9 times lower x-ray dose to obtain compared to an un-binned pixel.

In some cases, because the second image 204 is generated using relative less dose per image area, the first image 202 may be generated using normal x-ray dose, and the resulting image frame 200 will have a relatively less dose (compared to an image frame in which the entire image area is generated using normal x-ray dose). As used in this specification, “normal” x-ray dose refers to x-ray dose that is commonly used to obtain medical images, and may have a wide range of values. Also, in some cases, the first image 202 may be generated using higher x-ray dose (compared to the normal x-ray dose) to obtain a higher resolution, and the resulting image frame 200 may have the same or relatively less dose compared to an image frame in which the entire image area is generated using normal x-ray dose.

FIG. 3 illustrates a simulated image frame 300 showing an effect of binning image pixels in a region of interest (ROI). In particular, the image fame 300 has a first image 302 obtained using un-binned image signals, and a second image 304 obtained using binned image signals. As shown in the figure, the first image 302 (the central region where the ROI is located) has a higher resolution compared to the second image 304.

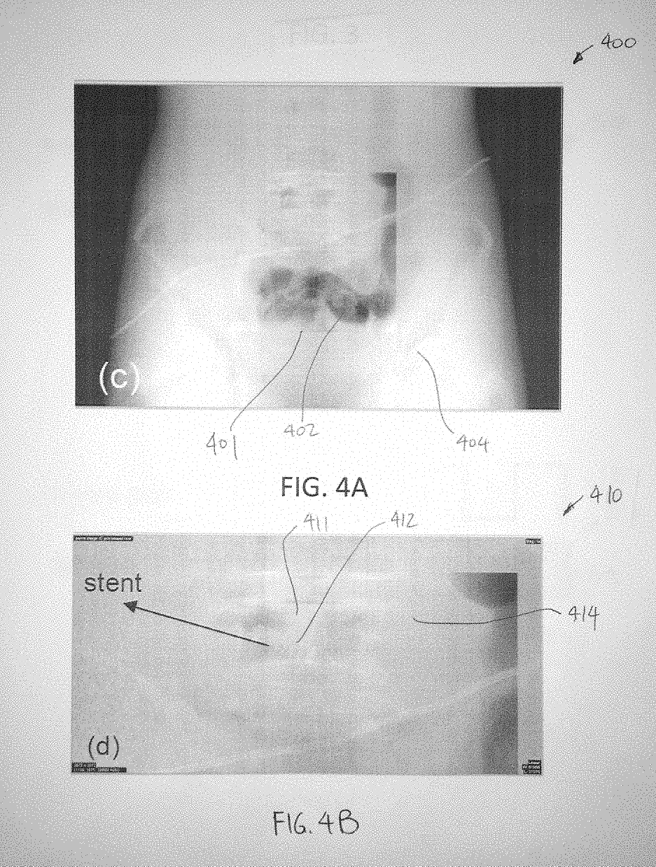

FIGS. 4A and 4B illustrate examples of images having different resolutions in each image. In particular, FIG. 4A shows an image frame 400 having a region of interest 401 with a first image 402, and a surrounding area with a second image 404, wherein the first image 402 has a first image resolution, and the second image 404 has a second image resolution that is lower than the first image resolution. Similarly, FIG. 4B shows an image frame 410 having a region of interest 411 with a first image 412, and a surrounding area with a second image 414, wherein the first image 412 has a first image resolution, and the second image 414 has a second image resolution that is lower than the first image resolution.

Various techniques may be employed to generate the image frame 200. In some embodiments, a collimator may be used to provide an imaging window for allowing the imager 26 to generate the first image 202 with a first size. The collimator may be a static collimator that has a fixed opening. Alternatively, the collimator may be a dynamic collimator with an adjustable opening so that the size of the opening may be adjusted. During use, the collimator is placed in the path of a radiation beam 32 being delivered by the x-ray source 22. The collimator blocks some of the radiation while allowing the rest of the radiation to go through its opening. The size and location of the collimator opening correspond with the size and location of the ROI in the image frame that is to be generated. The radiation exits from the collimator and goes through the patient for detection by the imager 26. The imager 26 generates image signals in response to the detected radiation. The image signals are read out and form the first image 202.

When generating the second image 204, the collimator may be removed from the path of the radiation beam 32. This allows the imager 26 to generate the second image 204 having a size that is larger than the size of the first image 202. If the collimator is a dynamic collimator, the opening of the collimator may be widened to provide a second imaging window that is larger than the first imaging window. The second imaging window allows the imager 26 to generate the second image 204 with a second size larger than the first size of the first image 202.

In some embodiments, the processing unit 14 is configured to operate the display 18 for displaying the first image 202 and the second image 204 together as respective parts of the image frame 200. In one implementation, the processing unit 14 is configured to superimpose the first image 202 over the second image 204 so that the first image 202 is at the correct position with respect to the second image 204. The resulting image is then displayed as the image frame 200. In another implementation, the processing unit 14 may be configured to remove a portion of the second image 204 that corresponds with the size and location of the first image 202. The processing unit 14 may then “stitch” the remaining second image 204 with the first image 202 to form the resulting image frame 200.

In other embodiments, the processing unit 14 is configured to operate the display 18 for displaying the first image 202 and the second image 204 sufficiently close in time so that they have an appearance of a single image frame. Before displaying the second image 204, the processing unit 14 may be configured to remove a portion of the second image 204 that corresponds with the size and location of the first image 202. Thus, as used in this specification, the term “image frame” is not limited to different images being displayed simultaneously to form an image frame, and may refer to different images of an image frame being displayed at different times.

In the above embodiments, the first image 202 is described with reference to having un-binned image signals. In other embodiments, the first image 202 may have binned image signals, wherein the amount of binning is less compared to that of the second image 204. For example, the first image 202 may have a pixel that is resulted from binning 2 rows and 2 column of image signals, while the second image 204 may have a pixel that is resulted from binning 3 rows and 3 column of image signals.

In some embodiments, the processing unit 14 may be a part of the display 18, a part of the imager 26, or a part of a processing system (e.g., a computing system, an iPad, iPhone, tablet, etc.). The processing unit 14 may be configured to create the second image 204. For example, the processing unit 14 may comprise circuitry in the imager 26 or coupled to the imager 26, for creating the second image 204 by binning two or more image signals from the image elements of the imager 26 to form a pixel signal. In other embodiments, the processing unit 14 is configured to receive the second image 204 from circuitry. For example, the processing unit 14 may be in the display 18 or in a separate processing system, configured to receive the second image 204 from circuitry that generates the second image 204. The circuitry may be at the imager 26 or may be coupled to the imager 26, and is configured to create the second image 204 by binning two or more image signals from the image elements of the imager 26 to form a pixel signal.

In the above embodiments, the same imager 26 is operated with different binning modes for generating different respective parts of an image frame. In other embodiments, the imager 26 may be operated in a different mode to create an image frame with different parts having different respective image resolutions. For example, in some embodiments, the collimator may be used with the imager 26 to create the first image 202 for the image frame 200, while the rest of the image frame 200 (i.e., the second image 204) is generated using previously generated image(s). In some cases, the processing unit 14 may generate the second image 204 by recursively processing previously generated images (e.g., by recursively collecting or combining image signals from previously generated images). In one implementation, a recursive filter may be used. A 90% recursively filtered image will have 10% contribution from the current image, and 90% contribution from the previously generated image(s). In particular, A 90% recursively filtered image may be achieved by combining a number (e.g., the last 10 or other numbers of previously generated images, or the previously generated images within the last 5 seconds or other durations, etc.) of previously generated images to obtain combined signal values, multiplying the combined signal values by 0.9, and then adding the result to 0.1 times the signal values of the current image. Other values (e.g., 50%, 100%, etc.) of recursive filtering may be used in other embodiments. The recursive filter may be a component of the processing unit 14, or may be a separate component. In the illustrated example, the previously generated images are generated using low-dose x-ray energy (i.e., lower than normal, or lower compared to that of the first image 202). In other cases, the previously generated images may be generated using normal dose x-ray energy, or higher dose x-ray energy. Thus, in some cases, the signal level in the second image 204 of the image frame 200 may be higher than the signal level in the first image 202, but the second image 204 will contain information from the previously generated images. In other cases, the signal level in the second image 204 of the image frame 200 may be the same as, or lower than, the signal level in the first image 202, but the x-ray dose involved in generating the second image 204 is less compared to that for generating the first image 202.

After the first and the second images 202, 204 are generated, the processing unit 14 then operates the display 18 to display both the first image 202 and the second image 204 together as the image frame 200. Techniques for combining the first image 202 and the second image 204 are described previously, and will not be repeated here.

In some embodiments, the above process may be repeated by the imager 26 and the processing unit 14 to generate a plurality of image frames 200 (forming a real time video), wherein each image frame 200 has the a first image 202 and a second image 204. In some cases, the first images 202 in the video may be read out in real time with the highest resolution (e.g., with un-binned signals), while the rest (i.e., the surrounding second image 204) of each image frame 200 in the video is generated using previously generated images (e.g., low dose images). The processing unit 14 may combine each first image 202 with a corresponding second image 204 to form each image frame 200, and may then operate the display 18 to display the image frame 200 as a part of the video.

In some embodiments, the signal in the non-ROI overview region may be enhanced by increasing a gain. In one implementation, charge storage capacitors may be used for providing a gain increase to form the second image 204. The increased signal will result in lowering the x-ray dose requirement in the non-ROI region. The increased signal also results in an increase of noise before a signal amplification (gain) stage. However, because the non-ROI region is for monitoring and land-marking, the increased noise should be acceptable.

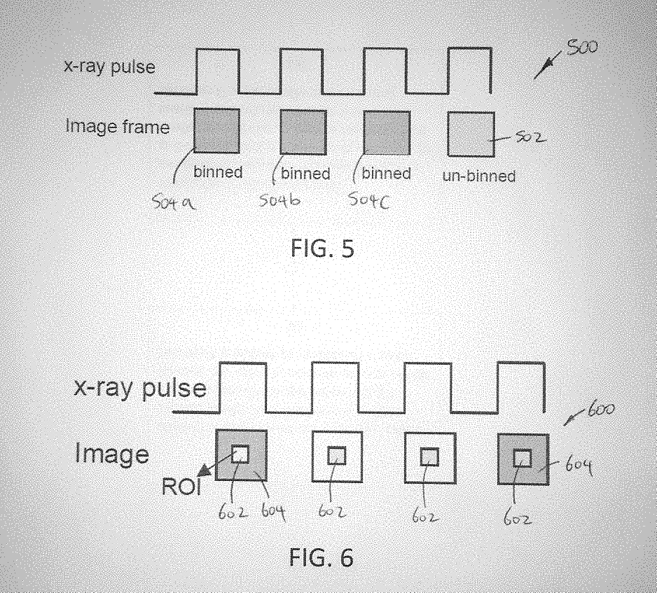

FIG. 5 illustrates another imaging technique for reducing dose while generating a sequence of image frames for a video. The imaging technique may be implemented using the imaging system 10 of FIG. 1, or other types of imaging system. In the illustrated embodiments, the imaging source 22 is activated to deliver radiation towards the patient 30, and the imager 26 generates image signals in response to detected radiation after it has passed through the patient 30. A collimator is not required, but it may be used if it is desirable to reduce a size of the images generated by the imager 26. The imager 26 is configured to generate both binned images and un-binned images in the sequence of image frames for the video 500. As shown in the figure, in the illustrated example, the imager 26 is configured to generate three binned images 504a, 504b, 504c, and then one un-binned image 502. This pattern continues so that every three binned images 504, there will be one un-binned image 502. Each of the un-binned images 502 may be generated by directly reading out pixel signals from the respective ones of the imaging elements in the imager 26. Each of the binned images 504 may be generated by binning multiple image signals to form binned image signals. The un-binned image 502 is similar to that discussed with reference to the first image 202 of FIG. 2, and the binned image 504 is similar to that discussed with reference to the second image 204 of FIG. 2. Thus, techniques for generating the un-binned images 502 and binned images 504 will not be described in further detail.

In the illustrated embodiments, the processing unit 14 is configured to operate the display 18 for displaying the un-binned images 502 (first plurality of images) and the binned images 504 (second plurality of images) in an interleaving manner so that they collectively form the video 500. As a result of this technique, the first plurality of images 502 will have a first image resolution, and the second plurality of images 504 will have a second image resolution that is lower than the first image resolution. Also, each of the images 502 will have an effective pixel size that is smaller than an effective pixel size of each of the images 504. Furthermore, the binned image 504 will require less dose to generate compared to the un-binned image 502.

In the above embodiments, the processing unit 14 is configured to operate the display 18 to display one of the first plurality of images 502 after N number of images 504 from the second plurality of images 504 in the video 500, where N is equal to three. In other embodiments, N may be less than three or more than three. Also, in other embodiments, instead of displaying only one un-binned image 502 after several binned images 504, multiple (e.g., two or more) un-binned images 502 may be displayed in a sequence after a number of binned images 504 have been displayed.

In further embodiments, the processing unit 14 may be configured to operate the display 18 to display one binned image 504 after N number of un-binned images 502 in the video 500, where N may be one, two, three, or more than three.

In still further embodiments, the number of binned images 504 in a sequence and the number of un-binned images 502 in a sequence in the video 500 may be variable. For example, in some cases, a user may operate a control (e.g., keyboard, mouse, touch pad, etc.) to cause the imager 26 to generate un-binned images. During use, the imager 26 may be configured to generate binned images by default. This has the benefit of allowing the user to generally see the internal region of the patient without requiring fine resolution. When the user is operating on the patient, the user may then operate the control to switch the operating mode of the imager 26 so that it generates un-binned images instead of binned images. The imager 26 may continue to generate un-binned images while the user is operating on the patient, so that the user can see the internal region of the patient in real time during the operation. When the fine resolution of the real time images is no longer needed, the user may then operate the control again to switch the operating mode of the imager 26 so that it generates binned images.

In other embodiments, the above configuration may be reversed. For example, in some cases, a user may operate a control (e.g., keyboard, mouse, touchpad, etc.) to cause the imager 26 to generate binned images. During use, the imager 26 may be configured to generate un-binned images by default. This has the benefit of allowing the user to generally see the internal region of the patient with fine resolution. When the user needs to take a pause during the treatment procedure, the user may then operate the control to switch the operating mode of the imager 26 so that it generates binned images instead of binned images. When the fine resolution of the real time images is needed again, the user may then operate the control again to switch the operating mode of the imager 26 so that it generates un-binned images.

FIG. 6 illustrates another imaging technique for reducing dose while generating a sequence of image frames for a video. The imaging technique may be implemented using the imaging system 10 of FIG. 1, or other types of imaging system. In the illustrated embodiments, a dynamic collimator is placed in the path of radiation beam 32. The dynamic collimator is operated to provide a first imaging window that corresponds with a location and size of the ROI. The imaging source 22 is then activated to deliver radiation towards the patient 30, and the imager 26 generates image signals in response to detected radiation after it has passed through the patient 30. As shown in the figure, the imager 26 generates a first plurality of images 602 at regular intervals (e.g., at a first frame rate) to form a part of the video 600. The dynamic collimator periodically widens its opening to provide a second imaging window that is larger than the first imaging window, which allows the imager 26 to receive more radiation to generate a second plurality of images 604. In the illustrated example, after every two image frames, the collimator widens its opening to allow a larger image frame having both the first image 602 and the second image 604 to be generated. Accordingly, the images 602 corresponding to the ROI are generated and displayed at a first frame rate, and the images 604 corresponding to the areas surrounding the ROI are generated and displayed at a second frame rate that is lower than the first frame rate. The processing unit 14 is configured to operate the display 18 for displaying the first plurality of images 602 and the second plurality of images 604 in a video. In particular, the processing unit 14 is configured to display the first plurality of images 602 in a first frame region of the video, and the second plurality of images 604 in a second frame region of the video, the first frame region being inside the second frame region.

In the illustrated embodiments, the first images 602 and the second images 604 have the same image resolution, and are generated with the same x-ray dose (per image area). However, because the areas surrounding the ROI are imaged at fewer frequency compared to the ROI area, the overall video will result in less dose delivered to the patient compared to the technique in which both the ROI are and the surrounding areas are imaged at the same frequency.

In other embodiments, the first plurality of images 602 may have a first image resolution, and the second plurality of images 604 has a second image resolution that is lower than the first image resolution. For example, when the second images 604 are generated, binning technique may be employed to allow the second images 604 to be generated using lower dose. In such cases, the second plurality of images 604 may have a frame rate that is the same as, or that is lower than, the frame rate of the first plurality of images 602. Accordingly, the frame rate of the second plurality of images 604 may be the same as, or different from, the frame rate of the first plurality of images 602.

Also, in the illustrated embodiments, at a certain image frame, both the first image 602 and the second image 604 are displayed simultaneously for that image frame. In other embodiments, the first image 602 and the second image 604 do not need to be displayed together. Instead, they may be displayed sufficiently close in time so that they provide an appearance of a single image frame. In either case, the first plurality of images 602 and the second plurality of images 604 may be considered to be interleaved in the video.

In some embodiments, the first plurality of images 602 has a first frame rate, and the second plurality of images 604 has a second frame rate that is lower than the first frame rate. In other embodiments, the first plurality of images 602 has a first frame rate, and the second plurality of images 604 has a second frame rate that is the same as the first frame rate.

In any of the embodiments described herein, the image having the lower image resolution and/or being generated with lower dose (e.g., the image 204, 304, or 504) is not limited to being generated using binning of image signals. In other embodiments, the imager 26 may be configured to provide slower image acquisition times to generate such image. In further embodiments, the imager 26 and/or the processing unit 14 may be configured to provide gain enhancement to generate such image. In still further embodiments, the imager 26 and/or the processing unit 14 may be configured to provide a combination of image signals binning, slower acquisition times, and gain enhancement to generate such image.

As illustrated in the above embodiments, the apparatus and method for medical imaging described herein are advantageous because they allow a sequence of image frames in a video to be generated while reducing an overall dose being delivered to a patient (reduced compared to technique in which all image frames in the video, and all parts in each image frame, are generated with the same dose or resolution). The apparatus and method are also advantageous because they allow the same normal or even higher dose to be applied to the ROI for generating high resolution image for area where it matters, while reducing dose being applied to areas surrounding the ROI for reducing resolution in those areas where high resolution is not required. Furthermore, the apparatus and method described herein are advantageous because they utilize a single imager to provide different types of images (e.g., images with different resolutions, dose requirements, etc.) by operating the imager in different modes. This is beneficial over use of a combination of two imaging systems to generate different respective types of images, which may be costly to implement. There may also be additional costs involved in integrating two separate imaging systems.

In the above embodiments, the imaging technique has been described with reference to a first image and a second image with different respective image resolutions. In other embodiments, the first image(s) and the second image(s) may have the same image resolution. Also, in other embodiments, the first image may have a first matrix size, and the second image may have a second matrix size that is different from the first matrix size. For example, the first image corresponding with the ROI may have a first matrix size that is larger than the second matrix size of the second image. The first image or the first matrix size corresponds with a first imaging dose, and the second image or the second matrix size corresponds with a second imaging dose that is different from the first imaging dose. In such cases, the respective resolutions of the first and second images may be the same or different.

In addition, in any of the embodiments described herein, the first image(s) (e.g., those corresponding with the ROI) may be generated using kV imaging, and the second image(s) may be generated using MV imaging.

Also, in any of the embodiments described herein, instead of operating the display, the processing unit may simply output the first image(s) and the second image(s) through respective outputs, or a same output. In one implementation, the processing unit may be a part of an image acquisition system having two physical digital outputs producing a video with the two types of images. In other cases, the image acquisition system may have a single digital output producing a video with the two types of images.

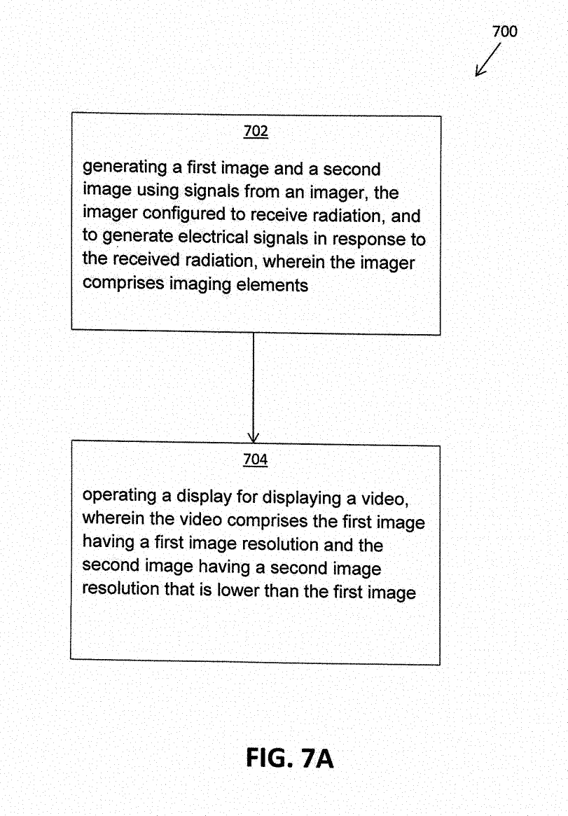

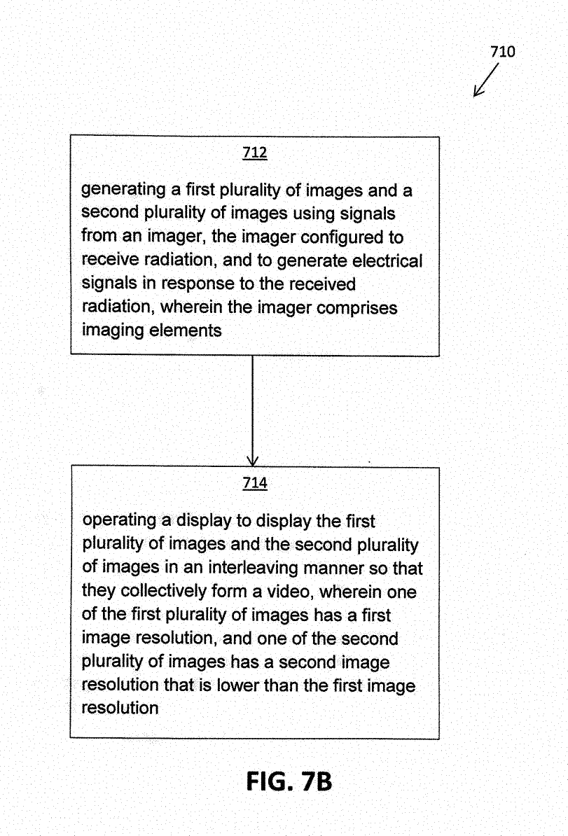

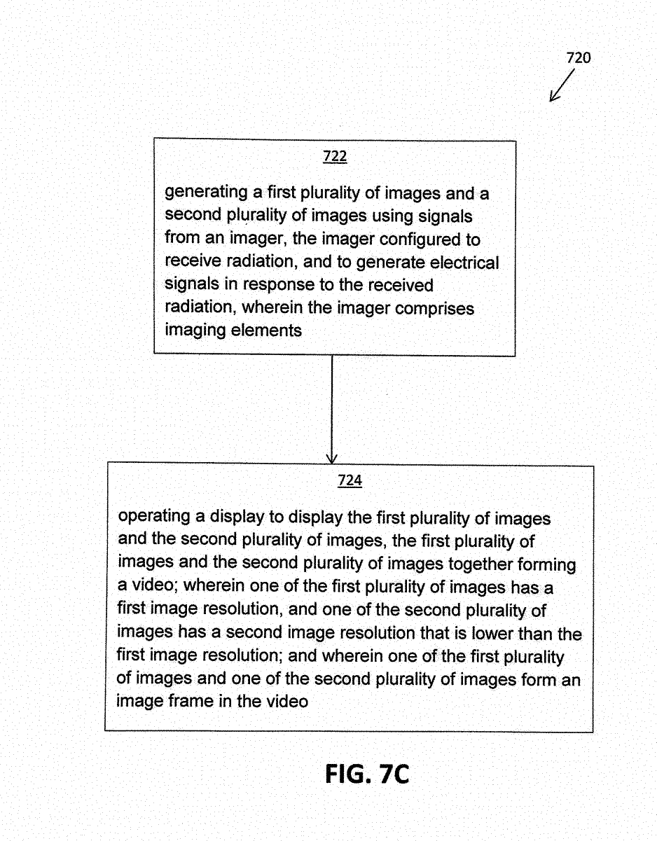

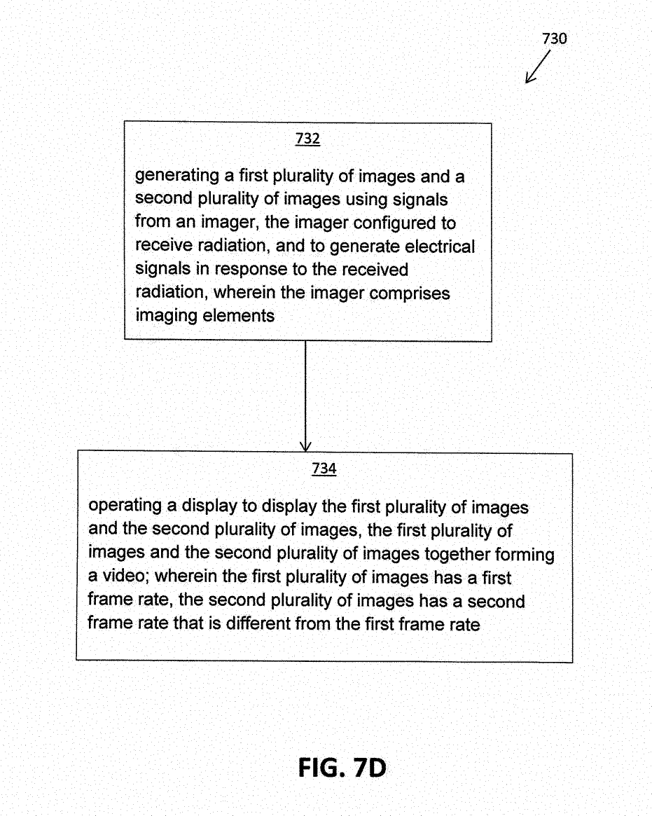

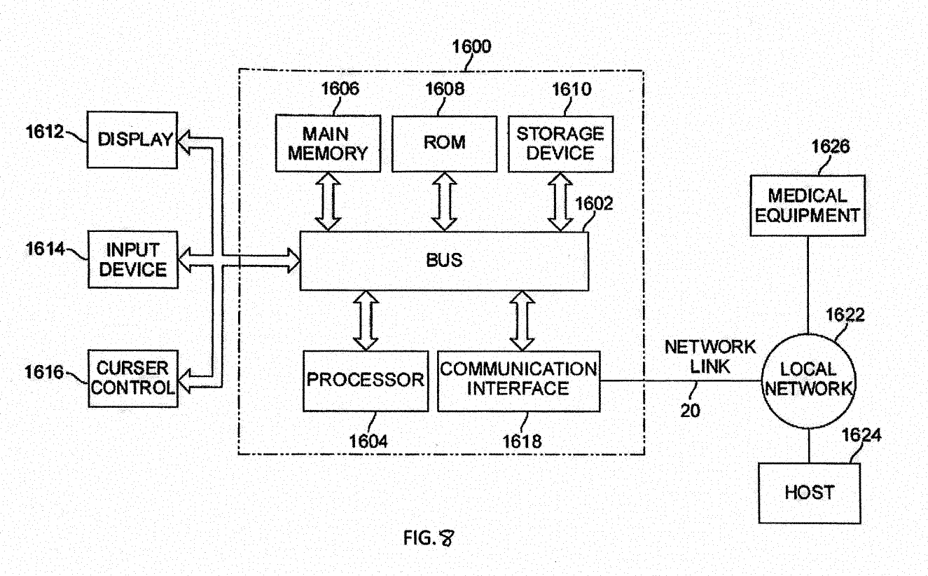

FIGS. 7A-7D illustrates various methods that are in accordance with one or more of the imaging techniques described above.

FIG. 7A illustrates a method 700 of medical imaging that includes: generating a first image and a second image using signals from an imager, the imager configured to receive radiation, and to generate electrical signals in response to the received radiation, wherein the imager comprises imaging elements (item 702); and operating a display for displaying a video, wherein the video comprises the first image having a first image resolution and the second image having a second image resolution that is different from (e.g., lower than) the first image (item 704). In other embodiments, instead of operating the display, a processing unit may simply output the first image and the second image through respective outputs (e.g., a first output for the first image, and a second output for the second image) or a same output.

Optionally, the first image comprises un-binned image signals.

Optionally, the second image comprises binned image signals.

Optionally, the first image has a first effective pixel size, and the second image has a second effective pixel size that is larger than the first effective pixel size.

Optionally, the first image is associated with a first dose, and the second image is associated with a second dose that is lower than the first dose.

Optionally, the method further includes using a collimator to perform radiation beam collimation.

Optionally, the method further includes using a collimator to provide a first imaging window for allowing the imager to generate the first image with a first size.

Optionally, the method further includes using the collimator to provide a second imaging window that is larger than the first imaging window for allowing the imager to generate the second image with a second size larger than the first size.

Optionally, the collimator comprises a static collimator or a dynamic collimator.

Optionally, the first image and the second image are displayed together as respective parts of an image frame.

Optionally, the first image and the second image are displayed sufficiently close in time so that they have an appearance of a single image frame.

Optionally, the second image is generated by a processing unit.

Optionally, the processing unit comprises circuitry, and the second image is created by the circuitry by binning two or more image signals from the imager to form a pixel signal.

Optionally, the method further includes receiving, by a processing unit, the second image from circuitry.

Optionally, the second image is created by the circuitry by binning two or more image signals from the imager to form a pixel signal.

Optionally, the second image is based at least in part on previously generated images.

Optionally, at least one of the previously generated images is generated using a lower dose compared to the first image.

Optionally, the second image is generated by a processing unit by recursively processing previously generated images.

Optionally, the second image is generated by using charge storage capacitors for providing a gain increase.

Optionally, the method further includes displaying a first plurality of images and a second plurality of images in an interleaving manner so that they collectively form the video; wherein one of the first plurality of images comprises the first image, and one of the second plurality of images comprises the second image.

Optionally, one of the first plurality of images is displayed after N number of images from the second plurality of images are displayed.

Optionally, one of the second plurality of images is displayed after N number of images from the first plurality of images are displayed.

Optionally, one of the second plurality of images is generated using a lower dose compared to one of the first plurality of images.

Optionally, the method further includes operating the display to display a first plurality of images, wherein one of the first plurality of images comprises the first image.

Optionally, the method further includes operating the display to display a second plurality of images; wherein one of the second plurality of images comprises the second image.

Optionally, the first plurality of images and the second plurality of images together form the video.

Optionally, the first plurality of images has a first frame rate, and the second plurality of images has a second frame rate that is lower than the first frame rate.

Optionally, the first plurality of images has a first frame rate, and the second plurality of images has a second frame rate that is the same as the first frame rate.

Optionally, the first plurality of images and the second plurality of images are interleaved in the video.

Optionally, the first plurality of images is displayed in a first frame region of the video, and the second plurality of images is displayed in a second frame region of the video, the first frame region being inside the second frame region.

FIG. 7B illustrates a method 710 of medical imaging that includes: generating a first plurality of images and a second plurality of images using signals from an imager, the imager configured to receive radiation, and to generate electrical signals in response to the received radiation, wherein the imager comprises imaging elements (item 712); and operating a display to display the first plurality of images and the second plurality of images in an interleaving manner so that they collectively form a video, wherein one of the first plurality of images has a first image resolution, and one of the second plurality of images has a second image resolution that is different from (e.g., lower than) the first image resolution (item 714). In other embodiments, instead of operating the display, a processing unit may simply output the first plurality of images and the second plurality of images through respective outputs (e.g., a first output for the first plurality of images, and a second output for the second plurality of images) or a same output.

Optionally, one of the first plurality of images is displayed after N number of images from the second plurality of images are displayed.

Optionally, one of the second plurality of images is displayed after N number of images from the first plurality of images are displayed.

Optionally, one of the second plurality of images is generated using a lower dose compared to one of the first plurality of images.

FIG. 7C illustrates a method 720 of medical imaging includes: generating a first plurality of images and a second plurality of images using signals from an imager, the imager configured to receive radiation, and to generate electrical signals in response to the received radiation, wherein the imager comprises imaging elements (item 722); and operating a display to display the first plurality of images and the second plurality of images, the first plurality of images and the second plurality of images together forming a video; wherein one of the first plurality of images has a first image resolution, and one of the second plurality of images has a second image resolution that is lower than the first image resolution; and wherein one of the first plurality of images and one of the second plurality of images form an image frame in the video (item 724). In other embodiments, instead of operating the display, a processing unit may simply output the first plurality of images and the second plurality of images through respective outputs (e.g., a first output for the first plurality of images, and a second output for the second plurality of images) or a same output.

Optionally, the first plurality of images has a first frame rate, and the second plurality of images has a second frame rate that is lower than the first frame rate.

Optionally, the first plurality of images has a first frame rate, and the second plurality of images has a second frame rate that is the same as the first frame rate.

Optionally, the first plurality of images is displayed in a first frame region of the video, and the second plurality of images is displayed in a second frame region of the video, the first frame region being inside the second frame region.

FIG. 7D illustrates a method 730 of medical imaging that includes: generating a first plurality of images and a second plurality of images using signals from an imager, the imager configured to receive radiation, and to generate electrical signals in response to the received radiation, wherein the imager comprises imaging elements (item 732); and operating a display to display the first plurality of images and the second plurality of images, the first plurality of images and the second plurality of images together forming a video; wherein the first plurality of images has a first frame rate, the second plurality of images has a second frame rate that is different from the first frame rate (item 734). In other embodiments, instead of operating the display, a processing unit may simply output the first plurality of images and the second plurality of images through respective outputs (e.g., a first output for the first plurality of images, and a second output for the second plurality of images) or a same output.

Optionally, the second frame rate is lower than the first frame rate.

Optionally, the first plurality of images and the second plurality of images are interleaved in the video.

Optionally, the first plurality of images is displayed in a first frame region of the video, and the second plurality of images is displayed in a second frame region of the video, the first frame region being inside the second frame region.

Optionally, one of the first plurality of images has a first image resolution, and one of the second plurality of images has a second image resolution that is lower than the first image resolution.

Specialized Processing System

FIG. 8 is a block diagram illustrating an embodiment of a specialized processing system 1600 that can be used to implement various embodiments described herein. For example, the processing system 1600 may be configured to implement the various imaging modes and techniques described herein. Also, in some embodiments, the processing system 1600 may be used to implement the processing unit 14 of FIG. 1, or any processing unit described herein.

Processing system 1600 includes a bus 1602 or other communication mechanism for communicating information, and a processor 1604 coupled with the bus 1602 for processing information. The processor 1604 may be an example of the processor 54 of FIG. 1, or an example of any processor described herein. The processing system 1600 also includes a main memory 1606, such as a random access memory (RAM) or other dynamic storage device, coupled to the bus 1602 for storing information and instructions to be executed by the processor 1604. The main memory 1606 also may be used for storing temporary variables or other intermediate information during execution of instructions to be executed by the processor 1604. The processing system 1600 further includes a read only memory (ROM) 1608 or other static storage device coupled to the bus 1602 for storing static information and instructions for the processor 1604. A data storage device 1610, such as a magnetic disk or optical disk, is provided and coupled to the bus 1602 for storing information and instructions.

The processing system 1600 may be coupled via the bus 1602 to a display 167, such as a cathode ray tube (CRT), for displaying information to a user. An input device 1614, including alphanumeric and other keys, is coupled to the bus 1602 for communicating information and command selections to processor 1604. Another type of user input device is cursor control 1616, such as a mouse, a trackball, or cursor direction keys for communicating direction information and command selections to processor 1604 and for controlling cursor movement on display 167. This input device typically has two degrees of freedom in two axes, a first axis (e.g., x) and a second axis (e.g., y), that allows the device to specify positions in a plane.

In some embodiments, the processing system 1600 can be used to perform various functions described herein. According to some embodiments, such use is provided by processing system 1600 in response to processor 1604 executing one or more sequences of one or more instructions contained in the main memory 1606. Those skilled in the art will know how to prepare such instructions based on the functions and methods described herein. Such instructions may be read into the main memory 1606 from another computer-readable medium, such as storage device 1610. Execution of the sequences of instructions contained in the main memory 1606 causes the processor 1604 to perform the process steps described herein. One or more processors in a multi-processing arrangement may also be employed to execute the sequences of instructions contained in the main memory 1606. In alternative embodiments, hard-wired circuitry may be used in place of or in combination with software instructions to implement the various embodiments described herein. Thus, embodiments are not limited to any specific combination of hardware circuitry and software.

The term “computer-readable medium” as used herein refers to any medium that participates in providing instructions to the processor 1604 for execution. Such a medium may take many forms, including but not limited to, non-volatile media, volatile media, and transmission media. Non-volatile media includes, for example, optical or magnetic disks, such as the storage device 1610. A non-volatile medium may be considered an example of non-transitory medium. Volatile media includes dynamic memory, such as the main memory 1606. A volatile medium may be considered an example of non-transitory medium. Transmission media includes coaxial cables, copper wire and fiber optics, including the wires that comprise the bus 1602. Transmission media can also take the form of acoustic or light waves, such as those generated during radio wave and infrared data communications.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer-readable media may be involved in carrying one or more sequences of one or more instructions to the processor 1604 for execution. For example, the instructions may initially be carried on a magnetic disk of a remote computer. The remote computer can load the instructions into its dynamic memory and send the instructions over a telephone line using a modem. A modem local to the processing system 1600 can receive the data on the telephone line and use an infrared transmitter to convert the data to an infrared signal. An infrared detector coupled to the bus 1602 can receive the data carried in the infrared signal and place the data on the bus 1602. The bus 1602 carries the data to the main memory 1606, from which the processor 1604 retrieves and executes the instructions. The instructions received by the main memory 1606 may optionally be stored on the storage device 1610 either before or after execution by the processor 1604.

The processing system 1600 also includes a communication interface 1618 coupled to the bus 1602. The communication interface 1618 provides a two-way data communication coupling to a network link 1620 that is connected to a local network 1622. For example, the communication interface 1618 may be an integrated services digital network (ISDN) card or a modem to provide a data communication connection to a corresponding type of telephone line. As another example, the communication interface 1618 may be a local area network (LAN) card to provide a data communication connection to a compatible LAN. Wireless links may also be implemented. In any such implementation, the communication interface 1618 sends and receives electrical, electromagnetic or optical signals that carry data streams representing various types of information.

The network link 1620 typically provides data communication through one or more networks to other devices. For example, the network link 1620 may provide a connection through local network 1622 to a host computer 1624 or to equipment 1626 such as a radiation beam source or a switch operatively coupled to a radiation beam source. The data streams transported over the network link 1620 can comprise electrical, electromagnetic or optical signals. The signals through the various networks and the signals on the network link 1620 and through the communication interface 1618, which carry data to and from the processing system 1600, are exemplary forms of carrier waves transporting the information. The processing system 1600 can send messages and receive data, including program code, through the network(s), the network link 1620, and the communication interface 1618.

In the above embodiments, the respiratory motion measuring apparatus 200 has been described with reference to it being used with a radiation machine in a radiation procedure (e.g., CT imaging, radiation treatment, etc.). However, it should be noted that the respiratory motion measuring apparatus 200 and the method 500 may be used with other types of machine and in other procedures. For example, the respiratory motion measuring apparatus 200 may be used with a proton machine in a proton treatment procedure, with an ultrasound machine in an ultrasound imaging and/or treatment procedure. Also, in other embodiments, the respiratory motion measuring apparatus 200 may be used in a data collection process that does not involve any treatment or medical imaging. For example, in other cases, the method 500 may be performed to determine a plurality of positional data representing breathing amplitudes of a patient. The positional data may be stored in a non-transitory medium for later use. For example, the positional data may be used later in a treatment process.

It should be noted that the term “image”, as used herein, is not limited to image that is visually displayed, and may alternatively be used to refer to image data that is stored, but not displayed visually. Also, terms like “first”, “second”, etc., are used to refer to different or separate items, and do not necessarily refer to order of items, unless explicitly stated otherwise.

Although particular embodiments have been shown and described, it will be understood that it is not intended to limit the claimed inventions to the preferred embodiments, and it will be obvious to those skilled in the art that various changes and modifications may be made without department from the spirit and scope of the claimed inventions. The specification and drawings are, accordingly, to be regarded in an illustrative rather than restrictive sense. The claimed inventions are intended to cover alternatives, modifications, and equivalents.

1. An apparatus for use in medical imaging, comprising:
an imager configured to receive radiation, and to generate electrical signals in response to the received radiation, wherein the imager comprises imaging elements; and
a processing unit configured to provide a video, wherein the video comprises a first image having a first image resolution and a second image having a second image resolution that is different from the first image, the first image and the second image generated using the imager.

2. The apparatus of claim 1, wherein the first image comprises un-binned image signals.

3. The apparatus of claim 1, wherein the second image comprises binned image signals.

4. The apparatus of claim 1, wherein the first image has a first effective pixel size, and the second image has a second effective pixel size that is different from the first effective pixel size.

5. The apparatus of claim 1, wherein the first image is associated with a first dose, and the second image is associated with a second dose that is different from the first dose.

6. The apparatus of claim 1, further comprising a collimator configured to operate with the imager.

7. The apparatus of claim 6, wherein the collimator is configured to provide a first imaging window for allowing the imager to generate the first image with a first size.

8. The apparatus of claim 7, wherein the collimator is also configured to provide a second imaging window that is different from the first imaging window for allowing the imager to generate the second image with a second size different from the first size.

9. The apparatus of claim 6, wherein the collimator comprises a static collimator or a dynamic collimator.

10. The apparatus of claim 1, wherein the processing unit is configured to output the first image and the second image together as respective parts of an image frame.

11. The apparatus of claim 1, wherein the processing unit is configured to output the first image and the second image sufficiently close in time so that they have an appearance of a single image frame.

12. The apparatus of claim 1, wherein the processing unit is configured to create the second image.

13. The apparatus of claim 12, wherein the processing unit comprises circuitry for creating the second image by binning two or more image signals from the imager to form a pixel signal.

14. The apparatus of claim 1, wherein the processing unit is configured to receive the second image from circuitry.

15. The apparatus of claim 14, wherein the circuitry is configured to create the second image by binning two or more image signals from the imager to form a pixel signal.

16. The apparatus of claim 1, wherein the second image is based at least in part on previously generated images.

17. The apparatus of claim 16, wherein at least one of the previously generated images is generated using a different dose compared to the first image.

18. The apparatus of claim 16, wherein the processing unit is configured to recursively process the previously generated images to obtain the second image.

19. The apparatus of claim 16, further comprising a signal gain changer to provide a gain change for the second image.

20. The apparatus of claim 1, wherein the processing unit is configured to generate a first plurality of images and a second plurality of images in an interleaving manner so that they collectively form the video; and
wherein one of the first plurality of images comprises the first image, and one of the second plurality of images comprises the second image.

21. The apparatus of claim 20, wherein the processing unit is configured to provide one of the first plurality of images after N number of images from the second plurality of images in the video.

22. The apparatus of claim 20, wherein the processing unit is configured to provide one of the second plurality of images after N number of images from the first plurality of images in the video.

23. The apparatus of claim 20, wherein one of the second plurality of images is generated using a different dose compared to one of the first plurality of images.

24. The apparatus of claim 1, wherein the processing unit is configured to generate a first plurality of images, wherein one of the first plurality of images comprises the first image.

25. The apparatus of claim 24, wherein the processing unit is also configured to provide a second plurality of images; wherein one of the second plurality of images comprises the second image.

26. The apparatus of claim 25, wherein the first plurality of images and the second plurality of images together form the video.

27. The apparatus of claim 26, wherein the first plurality of images has a first frame rate, and the second plurality of images has a second frame rate that is different from the first frame rate.

28. The apparatus of claim 26, wherein the first plurality of images has a first frame rate, and the second plurality of images has a second frame rate that is the same as the first frame rate.

29. The apparatus of claim 26, wherein the first plurality of images and the second plurality of images are interleaved in the video.

30. The apparatus of claim 25, wherein the processing unit is configured to provide the first plurality of images in a first frame region of the video, and the second plurality of images in a second frame region of the video, the first frame region being inside the second frame region.

31. The apparatus of claim 1, wherein the first image resolution is higher than the second image resolution.

32. The apparatus of claim 31, wherein the first image resolution is for a region of interest (ROI).

33. An apparatus for use in medical imaging, comprising:
an imager configured to receive radiation, and to generate electrical signals in response to the received radiation, wherein the imager comprises imaging elements; and
a processing unit configured to provide a first plurality of images and a second plurality of images in an interleaving manner so that they collectively form a video, wherein the first plurality of images and the second plurality of images are generated using the imager;
wherein one of the first plurality of images has a first image resolution, and one of the second plurality of images has a second image resolution that is different from the first image resolution.

34. The apparatus of claim 33, wherein the processing unit is configured to provide one of the first plurality of images after N number of images from the second plurality of images in the video.

35. The apparatus of claim 33, wherein the processing unit is configured to provide one of the second plurality of images after N number of images from the first plurality of images in the video.

36. The apparatus of claim 33, wherein one of the second plurality of images is generated using a different dose compared to one of the first plurality of images.

37. The apparatus of claim 33, wherein the processing unit is configured to output the one of the first plurality of images and the one of the second plurality of images together as respective parts of an image frame.

38. The apparatus of claim 33, wherein the processing unit is configured to output the one of the first plurality of images and the one of the second plurality of images sufficiently close in time so that they have an appearance of a single image frame.

39. The apparatus of claim 33, wherein the processing unit comprises circuitry for creating the one of the second plurality of images by binning two or more image signals from the imager to form a pixel signal.

40. The apparatus of claim 33, wherein the one of the second plurality of images is based at least in part on previously generated images.

41. The apparatus of claim 40, wherein at least one of the previously generated images is generated using a different dose compared to the one of the first plurality of images.

42. The apparatus of claim 40, wherein the processing unit is configured to recursively process the previously generated images to obtain the one of the second plurality of images.

43. An apparatus for use in medical imaging, comprising:
an imager configured to receive radiation, and to generate electrical signals in response to the received radiation, wherein the imager comprises imaging elements; and
a processing unit configured to provide a first plurality of images and a second plurality of images, the first plurality of images and the second plurality of images together forming a video;
wherein the first plurality of images and the second plurality of images are generated using the imager, and wherein one of the first plurality of images has a first image resolution, and one of the second plurality of images has a second image resolution that is different from the first image resolution; and
wherein one of the first plurality of images and one of the second plurality of images form an image frame in the video.

44. The apparatus of claim 43, wherein the first plurality of images has a first frame rate, and the second plurality of images has a second frame rate that is different from the first frame rate.

45. The apparatus of claim 43, wherein the first plurality of images has a first frame rate, and the second plurality of images has a second frame rate that is the same as the first frame rate.

46. The apparatus of claim 43, wherein the processing unit is configured to provide the first plurality of images in a first frame region of the video, and the second plurality of images in a second frame region of the video, the first frame region being inside the second frame region.

47. An apparatus for use in medical imaging, comprising:
an imager configured to receive radiation, and to generate electrical signals in response to the received radiation, wherein the imager comprises imaging elements; and
a processing unit configured to provide a first plurality of images and a second plurality of images, the first plurality of images and the second plurality of images together forming a video;
wherein the first plurality of images and the second plurality of images are generated using the imager; and
wherein the first plurality of images has a first frame rate, the second plurality of images has a second frame rate that is different from the first frame rate.

48. The apparatus of claim 47, wherein the second frame rate is lower than the first frame rate.

49. The apparatus of claim 47, wherein the first plurality of images and the second plurality of images are interleaved in the video.

50. The apparatus of claim 47, wherein the processing unit is configured to provide the first plurality of images in a first frame region of the video, and the second plurality of images in a second frame region of the video, the first frame region being inside the second frame region.

51. The apparatus of claim 47, wherein one of the first plurality of images has a first image resolution, and one of the second plurality of images has a second image resolution that is lower than the first image resolution.

52. An apparatus for use in medical imaging, comprising:
an imager configured to receive radiation, and to generate electrical signals in response to the received radiation, wherein the imager comprises imaging elements; and
a processing unit configured to provide a video, wherein the video comprises a first image having a first matrix size and a second image having a second matrix size that is different from the first matrix size, the first image and the second image generated using the imager;
wherein the first image corresponds with a first imaging dose, and the second image corresponds with a second imaging dose that is different from the first imaging dose.

53. An apparatus for use in medical imaging, comprising:
an imager configured to receive radiation, and to generate electrical signals in response to the received radiation, wherein the imager comprises imaging elements; and
a processing unit configured to provide a first plurality of images and a second plurality of images in an interleaving manner so that they collectively form a video, wherein the first plurality of images and the second plurality of images are generated using the imager;
wherein one of the first plurality of images has a first matrix size, and one of the second plurality of images has a second matrix size that is different from the first matrix size; and
wherein the one of the first plurality of images corresponds with a first imaging dose, and the one of the second plurality of images corresponds with a second imaging dose that is different from the first imaging dose.
